(19) United States
(12) Patent Application Publication
(10) Pub. No.: US 2006/0051289 A1
(43) Pub. Date: Mar. 9, 2006

(54) Method of directly heat supplying type reforming of natural gas

(75) Inventor: Keiichi Tomishige, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: JAPAN OIL, GAS AND METALS NATIONAL CORPORATION

(21) Appl. No.: 10/934,701

(22) Filed: Sep. 7, 2004

(51) Int. Cl. C01B 3/26

(52) U.S. Cl. 423/653

(57) ABSTRACT

In a Pt-modified Ni catalyst prepared by a sequential impregnation method, Pt metal atoms are heavily distributed chiefly on the surface of a Ni metal fine particle. By contrast, in a Pt-modified Ni catalyst prepared by a co-impregnation method, Pt metal atoms exist in the inside of the bulk of Ni metal.

### BACKGROUND OF THE INVENTION

1. Field of the Invention

The present invention relates to a method of directly heat supplying type reforming of lower hydrocarbons such as methane, ethane, propane, butane, their mixture, natural gas by which a catalytic combustion reaction field and a reforming reaction field are brought close to each other at an atomic/molecular level to transfer heat generated by a catalytic combustion reaction in reforming reaction effectively.

2. Description of Related Art

In recent years, environmental control concerning fuels and exhaust gases for transportation has become tighter every year, coming to a level unattainable by a conventional oil refinery technology. Accordingly, a fuel cell powered vehicle becomes a focus of attention. The fuel cell powered vehicle uses a solid polymer fuel cell; however, poisoning caused by sulfur has been raised as a problem. For this reason, it is necessary to reduce a sulfur concentration in the fuel to an extremely low level.

On the other hand, liquid fuels (methanol, synthesized gasoline, synthesized diesel oil, and dimethyl ether) can be produced via synthesis gas prepared by natural gas reforming or coal gasification, and all these liquid fuels do not contain sulfur at all. Therefore, it is assumed that these liquid fuels are not only supplied as clean fuels to conventional motor vehicles, but also adapted to new fuel cell systems very easily.

The emission-reduction of carbon dioxide has become a serious problem concurrently with the restrictions of sulfur, particulates, nitrogen oxides, and so on. From these view points, when synthesizing clean fuels by using the GTL process (Gas to Liquid; synthesis of liquid fuels from natural gas) or the like, a whole process where an input energy is held to minimum with energy efficiency is required. To be more specific, considering the GTL production via Fischer-Tropsch synthesis employing the natural gas as a raw material, a conversion from the natural gas to synthesis gas is an endothermic reforming reaction consuming a large amount of heat, and is carried out at a high temperature at around 1,300K. Therefore, this step requires very large amount of energy. By contrast, a conversion from the synthesis gas such as Fischer-Tropsch synthesis is an exothermic reaction in many cases, and proceeds at comparatively low temperature. This step requires not so large amount of energy. Thinking about whole process, enhancing efficiency of the synthesis gas preparation is a key step, and a development of production processes of the synthesis gas with high efficiency has been becoming more important.

Known methods of the synthesis gas production from natural gas include non-catalytic partial oxidation, steam reforming, carbon dioxide reforming, and auto-thermal reforming, and these producing methods excluding carbon dioxide reforming have already commercialized.

Of these producing methods, the auto-thermal reforming is a combination of non-catalytic partial oxidation reaction and steam/carbon dioxide reforming reaction.

In this method, feed hydrocarbons and oxygen are fed into reactor and the non-catalytic partial oxidation reaction (combustion with flame) proceeds in the front part of the reactor, heat generated in this part is transferred to a catalyst layer located in the rear part of the reactor, and the steam/carbon-dioxide reforming reaction proceeds on the catalyst. In this method, an exothermic reaction and an endothermic reaction proceed within the same reactor, therefore, the efficiency of the thermal transfer is higher than conventional steam reforming. Accordingly, in the terms of the efficiency of energy supplying, the auto-thermal reforming is superior to conventional method.

However, it has been pointed out that autothermal reforming has problems of soot formation and of too much increase of temperature in the non-catalytic partial oxidation portion.

Another autothermal reforming method which is a combination of catalytic combustion and steam/carbon-dioxide reforming has also been investigated.

In this method (hereinafter, referred to as internal-heat supplying type reforming), when the catalytic combustion reaction proceeds in the catalyst layer, the catalytic combustion reaction rate of hydrocarbons is generally an order of magnitude greater than the reforming reaction rate of hydrocarbon. Therefore, the catalytic combustion of feed hydrocarbon more likely proceeds in the inlet side of the catalytic layer, and the reforming reaction proceeds in the area located backward. For this reason, there occurs a greatly large temperature gradient in the catalytic layer. Further, particularly when nickel supported catalyst which is preferably used as a conventional reforming catalyst is employed for this method, a part of nickel on the catalyst is oxidized, then catalyst has different chemical states consisting of an oxidation state and a reduction state. Consequently, the nickel catalyst layer can be substantially divided into oxidation area catalyzed oxidized nickel and reforming area catalyzed reduced nickel. For this reason, in the case of internal-heat supplying type reforming, the appearance of new catalyst is expected, which contributes to efficient heat supply from the catalytic combustion reaction field to the reforming reaction field by locating the catalytic combustion reaction field and the reforming reaction field close to each other.

Under the existing condition, the present inventor has conducted earnest studies with the aim of developing a catalytic reaction system, which more efficiently supplies heat from the catalytic combustion reaction field to the reforming reaction field by locating the combustion reaction field and the reforming reaction field close to each other at an atomic/molecular level, and has come to present a scientific paper before. For example, the inventor discloses in the paper (Applied Catalysis A: General 223 (2002) pp. 225-238) that a platinum catalyst has a high reforming activity, locating the catalytic combustion reaction field where generate reaction heat with high temperature and the reforming reaction field where consume a lot of heat and require high temperature close to each other, and enabling the transfer of the heat energy efficiently and directly (directly heat supplying type reforming). That is, when an oxygen affinity of metal, which is an index for evaluating the stabilities of a metallic state and of the state of a metal oxide, is used as an index, it is supposed that nickel exists as the oxide in the catalyst layer portion within the reactor where oxygen exists. Because the nickel oxide has extremely low reforming activity as compared to the metal nickel, the catalytic combustion and the reforming reaction cannot proceed at the same portion of the catalyst simultaneously. By contrast, precious metals such as platinum are stable in metallic states, with the existence of oxygen keeping their metallic states all over the catalyst layer during synthesis gas production.

However, directly heat supplying type reforming using platinum catalyst mentioned above has the problem that the used amount of precious metals such as platinum directly raises the catalyst cost, thereby making it difficult to be commercialized.

### SUMMARY OF THE INVENTION

Since the present invention has been accomplished to solve the above-mentioned problem, an object of the present invention is to provide a method of directly heat supplying type reforming of lower hydrocarbons such as methane, ethane, propane, butane, their mixture, and natural gas which uses a catalyst capable of maintaining a high reforming activity even if the used amount of precious metals such as platinum is reduced.

A method of directly heat supplying type reforming of lower hydrocarbons according to one aspect of the present invention is characterized in that a catalytic combustion reaction and a reforming reaction of lower hydrocarbons are performed in the same reaction field under the presence of a nickel (referred to as Ni hereinafter) catalyst that is modified with at least one precious metal selected from the group consisting of platinum (referred to as Pt hereinafter), palladium (referred to as Pd hereinafter), rhodium (referred to as Rh hereinafter), and ruthenium (referred to as Ru hereinafter) by a sequential impregnation method.

As mentioned above, according to the present invention, because it is arranged that the catalytic combustion reaction and the reforming reaction of lower hydrocarbons be performed in the same reaction field under the presence of a precious-metal-modified Ni catalyst prepared by means of a sequential impregnation method, the method of directly heat supplying type reforming of natural gas, showing a high conversion rate and having an excellent energy supplying efficiency, can be carried out at a comparatively low cost because of the reduction of expensive precious metal consumption.

Moreover, the method of directly heat supplying type reforming of lower hydrocarbon according to another aspect of the present invention uses a Pt-modified Ni catalyst as a catalyst.

Therefore, according to the present invention, the method of directly heat supplying type reforming of lower hydrocarbon, which shows a high conversion rate and has an excellent energy supplying efficiency, can be carried out at a comparatively low cost.

Furthermore, the method of directly heat supplying type reforming of natural gas according to still another aspect of the present invention uses aluminum oxide (referred to as Al₂O₃ hereinafter) or zirconium oxide (referred to as ZrO₂ hereinafter) as the carrier of the catalyst.

Therefore, according to the present invention, the method of directly heat supplying type reforming of natural gas can be carried out, which can suppress the temperature rise of the Ni catalyst layer modified with a small amount of precious metal, to thereby reduce the formation of a hot spot at the inlet side of the catalyst layer, and has an excellent efficiency of energy transfer from the catalytic combustion reaction field to the reforming reaction field.

### BRIEF DESCRIPTION OF THE DRAWINGS

FIG. 1A is a schematic diagram showing the fine structure of a Pt-modified Ni catalyst prepared by a sequential impregnation method;

FIG. 1B is a schematic diagram showing the fine structure of a Pt-modified Ni catalyst prepared by a co-impregnation method;

FIG. 2 is a schematic sectional view showing the internal configuration of the fixed bed reactor used for the method of directly heat supplying type reforming of natural gas;

FIG. 3 is a graph showing the W/F dependence of the temperature distribution on the catalyst in the internal-heat supplying type reforming reaction of methane studied about Example 1 of the present invention;

FIG. 4 is a graph showing the W/F dependence of the temperature distribution on the catalyst in the internal-heat supplying type reforming reaction of methane studied about Example 2 of the present invention;

FIG. 5 is a graph showing the W/F dependence of the temperature distribution on the catalyst in the internal-heat supplying type reforming reaction of methane studied about Comparative Example 1; and

FIG. 6 is a graph showing the temperature distributions in the internal-heat supplying type reforming of methane on the various catalysts.

### DETAILED DESCRIPTION OF THE PREFERRED EMBODIMENTS

An embodiment of the present invention will be described below.

### Embodiment 1

A feature of the method of directly heat supplying type reforming of lower hydrocarbons according to Embodiment 1 of the present invention is that the catalytic combustion reaction and the reforming reaction of lower hydrocarbons are carried out in the same reaction field in the presence of a Ni catalyst modified with Pt (referred to as a Pt-modified Ni catalyst hereinafter) by a sequential impregnation method.

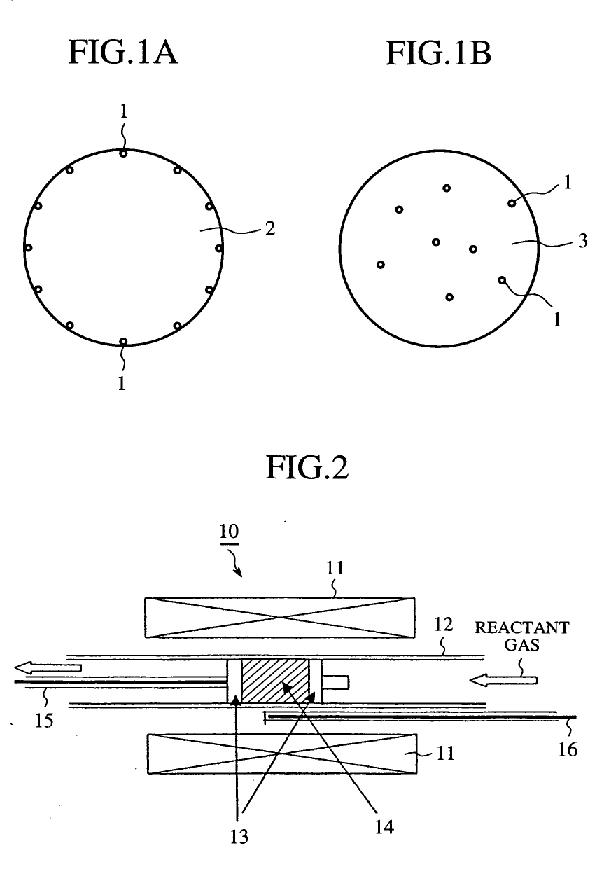

As shown in FIG. 1A, it is assumed that in the Pt-modified Ni catalyst prepared by the sequential impregnation method, Pt metal atoms 1 are heavily distributed chiefly on the surface of a Ni metal fine particle 2. Thereby, the Pt-modified Ni catalyst shows a high reforming activity and a stable temperature distribution as compared with a Ni single catalyst and a Pt single catalyst, and a remarkable additive effect of Pt is obtained therefrom. By contrast, as shown in FIG. 1B, it is assumed that in the Pt-modified Ni catalyst prepared by a co-impregnation method, Pt metal atoms 1 exist within a Ni metal bulk 3, and that the Ni catalyst shows the behavior, which is very similar to that of a Ni single catalyst, and does not bring about the additive effect of Pt.

The carriers of the Pt-modified Ni catalyst include Al₂O₃, ZrO₂, MgO, CeO₂, and SiO₂, which are known carriers; however, of these carriers, particularly, Al₂O₃ or ZrO₂ can be preferably used. Temperature rise of the catalyst can be suppressed when the Ni catalyst modified with a small amount of precious metal supported the Al₂O₃ or ZrO₂ carrier is used for direct heat supplying reforming, thereby the formation of a hot spot at the inlet side of the catalytic layer is also suppressed. This enables the method of directly heat supplying type reforming of lower hydrocarbons, which has an excellent efficiency of energy supplying from the catalytic combustion reaction field to the reforming reaction field, to be carried out. Moreover, the loading of Pt in the Pt-modified Ni catalyst is preferably selected in the range of from 1.5×10⁻⁶ moles to 1.5×10⁻⁵ moles per gram of the catalyst. When the loading of Pt is less than the lower limit, the desired conversion rate is not obtained, and when it is over the upper limit, the catalyst cost increases, while the conversion rate reaches saturation.

A fixed bed reactor is suitably used as a reactor in Embodiment 1. The fixed bed reactor 10 is, for example, as shown in FIG. 2, generally composed of a cylindrical heater 11, a quartz tube 12 provided in this heater 11, a pair of quartz cottons 13 provided in this tube 12, a catalytic layer 14 housed such that it is sandwiched between these quartz cottons 13, thin quartz tube 15 with dead-end in which thermocouple is inserted that measures the temperature distribution of catalyst layer, and the thermocouple 16 that measures the temperature of the external wall of the tube 12. The tube 12 is arranged such that reactant gas is introduced therein along the arrow.

The above Embodiment will now be specifically described by way of Examples and Comparative Examples as below.

### EXAMPLE 1

First of all, an aqueous solution of nickel nitrate (Ni(NO₃)₂) containing Al₂O₃ (Aerosil Co. Inc.) was dried at 393K for 12 h, and then was calcinated at 773K for 3 h in a muffle furnace. Further, the obtained product was molded into disks at 600 kg/cm² with a uniaxial molder, followed by grinding, and then sieving to particles with 60-100 meshes through use of a sieve. Subsequently, the obtained product was reduced with hydrogen at 1,123K for 0.5 h. This catalyst was impregnated with acetone containing acetylacetonato platinum, and dried at 393K for 12 h, followed by calcination at 573K for 3 h, and then reducing with hydrogen at 1,123K for 0.5 h. The Pt-modified Ni catalyst prepared by such a sequential impregnation method includes Pt(0.3)/Ni(10)/Al₂O₃.

### EXAMBPLE 2

A Pt-modified Ni catalyst was prepared similarly as in Example 1 except that the loading of Pt was reduced. The Pt-modified Ni catalyst prepared by such a sequential impregnation method includes Pt(0.1)/Ni(10)/Al₂O₃.

### COMPARATIVE EXAMPLE 1

First of all, a mixed aqueous solution of nickel nitrate (Ni(NO₃)₂) and chloroplatinic acid (H₂PtCl₆) containing Al₂O₃ (Aerosil Co. Inc.) was prepared. This solution was dried at 393K for 12 h, then calcinated at 773K for 3 h in a muffle furnace, and molded into disks at 600 kg/cm² with a uniaxial molder, followed by grinding, then sieving to particles with 60-100 meshes through use of a sieve, and reducing with hydrogen at 1,123K for 0.5 h. The Pt-modified Ni catalyst prepared by such a co-impregnation method includes Pt(0.3)+Ni(10)/Al₂O₃.

### COMPARATIVE EXAMPLE 2

First of all, an aqueous solution of chloroplatinic acid (H₂PtCl₆) containing Al₂O₃ (Aerosil Co. Inc.) was prepared. This solution was dried at 393K for 12 h, then calcinated at 773K for 3 h in a muffle furnace, and molded into disks at 600 kg/cm² with a uniaxial molder, followed by grinding, then sieving to particles with 60-100 meshes through use of a sieve, and reducing with hydrogen at 1,123K for 0.5 h. The Pt catalyst prepared by such an impregnation method includes Pt(0.3)/Al₂O₃.

### COMPARATIVE EXAMPLE 3

A Pt catalyst was prepared similarly as in Comparative Example 2 except that the loading of Pt was reduced. The Pt catalyst prepared by such an impregnation method includes Pt(0.1)/Al₂O₃.

### COMPARATIVE EXAMPLE 4

First of all, an aqueous solution of nickel nitrate (Ni(NO₃)₂) containing Al₂O₃ (Aerosil Co. Inc.) was prepared. This solution was dried at 393K for 12 h, then calcinated at 773K for 3 h in a muffle furnace, and molded into disks at 600 kg/cm² with a uniaxial molder, followed by grinding, then sieving to particles with 60-100 meshes through use of a sieve, and hydrogen-reducing at 1,123K for 0.5 h. The Ni catalyst prepared by such an impregnation method includes Ni(10)/Al₂O₃.

Each of the above-described catalysts of Examples 1, 2, and Comparative Examples 1-4 was charged into the tube 12 of the fixed bed reactor 10 shown in FIG. 2. The catalyst characteristic thereof in the internal-heat supplying type reforming reaction of methane was examined, and is shown in Table 1. The reaction conditions are as follows: the external wall temperature of the reactor was kept at 1,123K, volumetric composition of the reactant gas was CH₄/CO₂/O₂/Ar=40/40/20/0, the ratio of the weight (W) of the catalyst and the total flow rate (F) of the introduced gas (referred to as W/F hereinafter) was 0.4 gh/mol, and the total pressure is 0.1 MPa.

TABLE 1

| | | Methane | CO₂ Gas | |
|---|---|---|---|---|
| | W/F | Conversion | Conversion | |
| Catalyst | (ghmol⁻¹) | Rate(%) | Rate(%) | H₂/CO |
| Pt(0.3)/Al₂O₃ | 0.4 | 78 | 40 | 0.89 |
| (Comparative | 0.33 | 75 | 38 | 0.88 |
| Example 2) | 0.27 | 70 | 36 | 0.85 |
| | 0.13 | 58 | 29 | 0.82 |
| Pt(0.1)/Al₂O₃ | 0.4 | 61 | 32 | 0.82 |
| (Comparative | 0.33 | 55 | 27 | 0.76 |
| Example 3) | 0.27 | 45 | 24 | 0.62 |
| | 0.13 | 41 | 19 | 0.58 |
| Ni(10)/Al₂O₃ | 0.4 | 86 | 43 | 0.87 |
| (Comparative | 0.33 | 72 | 34 | 0.75 |
| Example 4) | 0.27 | 52 | 25 | 0.62 |
| | 0.13 | 37 | 17 | 0.48 |
| Pt(0.3)/Ni(10)/ | 0.4 | 96 | 47 | 0.96 |
| Al₂O₃: Sequential | 0.33 | 90 | 40 | 0.92 |
| Impregnation | 0.27 | 79 | 37 | 0.84 |
| (Example 1) | 0.13 | 68 | 34 | 0.8 |
| Pt(0.1)/Ni(10)/ | 0.4 | 82 | 41 | 0.85 |
| Al₂O₃: Sequential | 0.33 | 76 | 38 | 0.82 |
| Impregnation | 0.27 | 68 | 32 | 0.78 |
| (Example 2) | 0.13 | 58 | 30 | 0.72 |
| Pt(0.3) + Ni(10)/ | 0.4 | 88 | 44 | 0.90 |
| Al₂O₃: | 0.33 | 75 | 36 | 0.81 |
| Co-impregnation | 0.27 | 62 | 32 | 0.66 |
| (Comparative | 0.13 | 48 | 26 | 0.56 |
| Example 1) | | | | |

As is apparent from Table 1, Example 1 employing the catalyst prepared by the sequential impregnation method shows a higher conversion rate than Comparative Example 1 employing the catalyst prepared by the co-impregnation method. Moreover, Example 1 shows a higher conversion rate as compared with the activity of Comparative Examples 2-4 all having a single metal composition. In addition, Comparative Example 1 obtained by the co-impregnation method shows a conversion rate, which is almost equal to that of Comparative Example 4, in the high W/F region. This indicates that the effect of addition of Pt does not so much manifest itself therein.

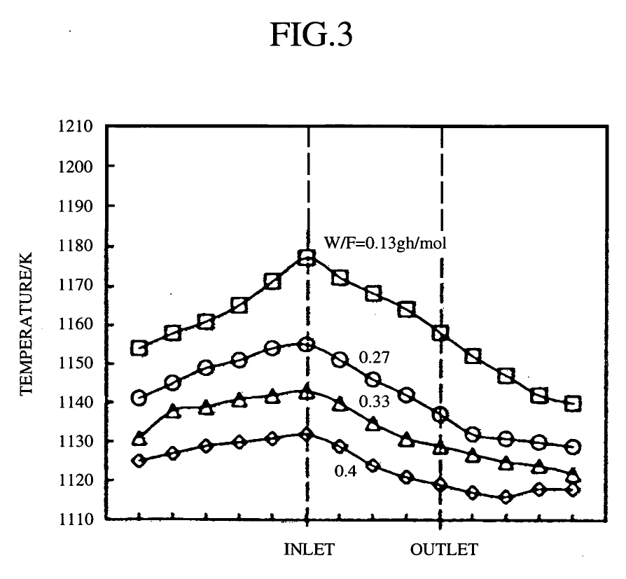

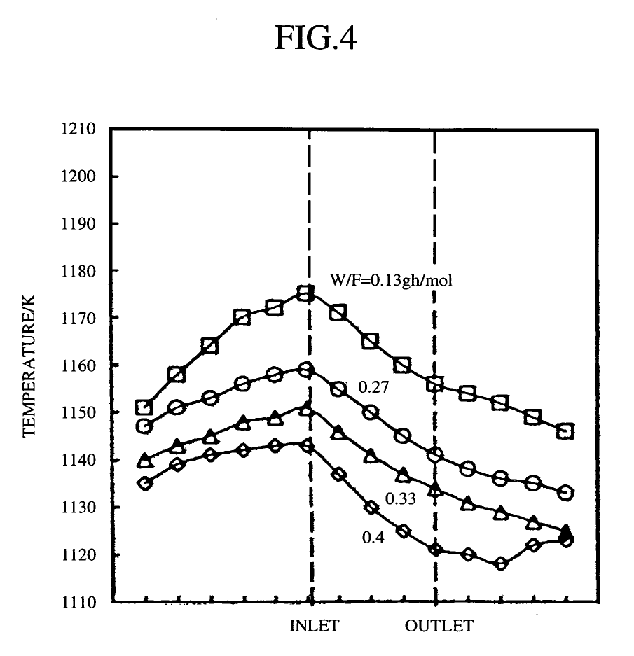

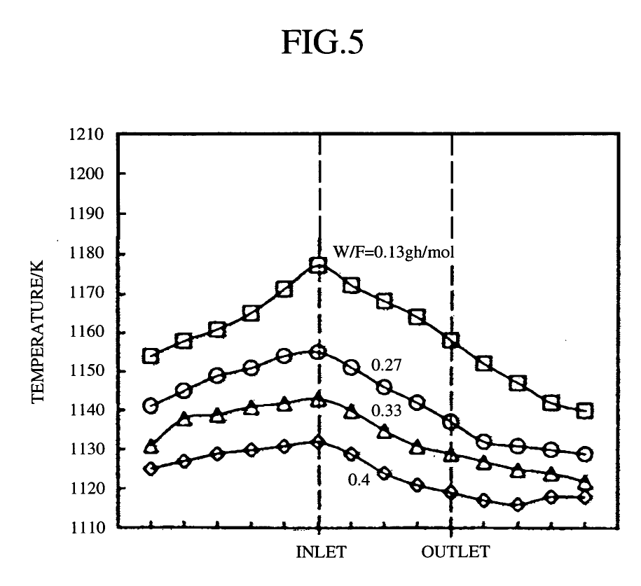

Subsequently, the W/F dependence of the temperature distribution on the catalyst in the internal-heat supplying type reforming reaction of methane was examined about Example 1, Example 2, and Comparative Example 1. The results are shown in FIGS. 3-5. Here, the reaction conditions were as follows: the external wall temperature of the reactor was 1,123K, the reactant gas composition was CH₄/CO₂/O₂/Ar=40/40/20/0, and the total pressure was 0.1 MPa. TheW/F was set to 0.13, 0.27, 0.33, and 0.4 gh/mol. Comparative examination of FIGS. 3-5 shows that the temperature does not easily increase on the catalysts prepared by the sequential impregnation method in Example 1 and Example 2. Particularly in Example 1, this effect is most remarkable. Examination based on these results reveals that the added Pt functions effectively in the Pt-modified Ni catalyst prepared by the sequential impregnation method as compared with the one prepared by the co-impregnation method.

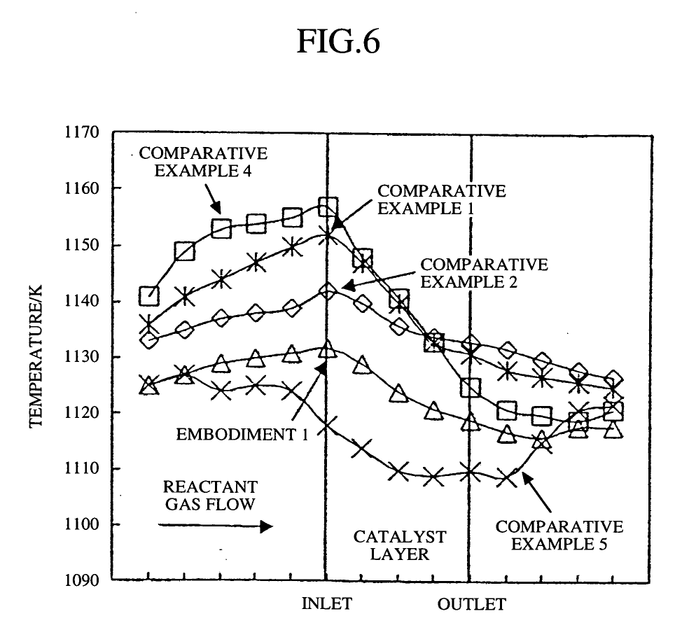

Subsequently, the distribution of temperature on the catalyst in the internal-heat supplying type reforming reaction of methane was examined about Example 1 and Comparative Examples 1, 2, 4, and 5, and the results are shown in FIG. 6. In Comparative Example 5, the Pt catalyst was prepared similarly as in Comparative Example 2 except that the loading of Pt was increased, and the prepared Pt catalyst includes Pt(10)/Al₂O₃. The reaction conditions were as follows: the external wall temperature of the reactor was 1,123K, the reactant gas composition was CH₄/CO₂/O₂/Ar=40/40/20/0, the W/F was 0.4 gh/mol, and the total pressure was 0.1 MPa. At that time, the methane conversion rates obtained by these catalysts were 96% (Example 1), 88% (Comparative Example 1), 78% (Comparative Example 2), 86% (Comparative Example 4), and 99% (Comparative Example 5).

In FIG. 6, comparative examination of the catalysts shows that Comparative Example 1 using the Pt-modified Ni catalyst prepared by the co-impregnation method looks similar to Comparative Example 4 using the Ni catalyst in the activity and also in the temperature distribution. Meanwhile, it is clear that Example 1 using the Pt-modified Ni catalyst prepared by the sequential impregnation method suppresses the temperature to a lower level, and shows a higher conversion rate than Comparative Example 2 using the Pt single modification. Also in the conversion rate, Example 1 shows a high activity that is substantially equal to that of Comparative Example 5 in which the loading is comparatively high. These results shows that because Comparative Example 1 where the Pt-modified Ni catalyst was prepared by the co-impregnation method, has little effect of addition of Pt, the Pt metal atoms are highly probably incorporated in the inside of Ni metal bulk as shown in FIG. 1B, in the Pt-modified Ni catalyst prepared by the co-impregnation method. By contrast, in the Pt-modified Ni catalyst prepared by the sequential impregnation method, the additive effect of Pt appears remarkably, and the higher activity and the lower temperature of the catalytic layer are achieved particularly compared with Comparative Example 2 and Comparative Example 4 both using the Pt single catalyst. This indicates that in this catalyst prepared by the sequential impregnation method, the Pt metal atoms are efficiently exposed on the surface of the Ni metal atom as shown in FIG. 1A, and Pt and Ni cooperatively function.

As mentioned above, according to Embodiment 1, because it is arranged that the catalytic combustion reaction and the reforming reaction of lower hydrocarbons be performed in the same reaction field in the presence of the Pt-modified Ni catalyst prepared by means of the sequential impregnation method, the method of directly heat supplying type reforming of natural gas, showing a high conversion rate and having an excellent energy-supplying efficiency, can be carried out at a comparatively low cost.

Additionally, though in Embodiment 1, Pt is used as the precious metal in the precious-metal-modified Ni catalyst, Pd, Rh, and Ru can be also used, in addition to Pt. Here, the precious metal atom with which the Ni catalyst is modified is not limited to one type, but the metal can be selected from the group consisting of Pt, Pd, Rh, and Ru, and a suitable combination of these metals can be selected.

Furthermore, in Embodiment 1, the fixed bed reactor 10 was employed as the reactor; however, the present invention is not limited to the fixed bed reactor, but the invention can be put into practice suitably in a fluidized bed reactor.

What is claimed is:

1. A method of directly heat supplying type reforming of lower hydrocarbons, wherein an oxidation reaction and a reforming reaction of natural gas are performed in the same reaction field under the presence of a nickel catalyst that is modified with at least one precious metal selected from the group consisting of platinum, palladium, rhodium, and ruthenium by a sequential impregnation method.

2. A method of directly heat supplying type reforming of lower hydrocarbons according to claim 1, wherein the catalyst is a platinum-modified nickel catalyst.

3. A method of directly heat supplying type reforming of lower hydrocarbons according to claim 2, wherein the carrier of the catalyst is aluminum oxide or zirconium oxide.

4. A method of directly heat supplying type reforming of lower hydrocarbons according to claim 1, wherein the lower hydrocarbon is methane, ethane, propane, butane or natural gas.
